(19) United States
(12) Patent Application Publication
(10) Pub. No.: US 2015/0144621 A1
(43) Pub. Date: May 28, 2015

(54) MATCHING METHOD AND MICROWAVE HEATING METHOD

(71) Applicant: TOKYO ELECTRON LIMITED, Tokyo (JP)

(72) Inventors: Seokhyoung HONG, Yamanashi (JP); Mitsutoshi ASHIDA, Yamanashi (JP); Yoshihiro MIYAGAWA, Yamanashi (JP); Masaki KOIZUMI, Yamanashi (JP)

(21) Appl. No.: 14/549,175

(22) Filed: Nov. 20, 2014

(30) Foreign Application Priority Data
Nov. 25, 2013 (JP) 2013-242606

(51) Int. Cl. H05B 6/68; H05B 6/64

(52) U.S. Cl. CPC H05B 6/68; H05B 6/6447
USPC 219/709

(57) ABSTRACT

A matching method and a microwave heating method in a microwave heating apparatus for heating a substrate by introducing a microwave into a processing chamber comprises an initial matching step of performing a matching so that a reflection power to a microwave introducing unit is minimized in a state where the substrate is maintained at a first height position by a supporting member. And a second height position determination step of introducing the microwave into the processing chamber by the microwave introducing unit and determining a second height position of the substrate based on at least a temperature of the substrate while adjusting a height of the substrate by the supporting member.

### CROSS-REFERENCE TO RELATED APPLICATIONS

This application claims priority to Japanese Patent Application No. 2013-242606 filed on Nov. 25, 2013, the entire contents of which are incorporated herein by reference.

### FIELD OF THE INVENTION

The present invention relates to a matching method and a microwave heating method in a microwave heating apparatus for heating a substrate by introducing a microwave into a processing chamber.

### BACKGROUND OF THE INVENTION

Recently, an apparatus using a microwave is suggested as an apparatus for performing an annealing process on a substrate such as a semiconductor wafer or the like. The annealing process using a microwave may be internal heating, local heating and selective heating and thus is advantageous in its high processing efficiency compared to a conventional annealing apparatus using lamp heating or resistance heating. For example, when doping atoms are activated by microwave heating, a microwave directly acts on the doping to and, thus, excessive heating does not occur and diffusion of a diffusion layer can be suppressed. Since the microwave irradiation is used, an annealing process can be performed at a relatively low temperature and an increase in a thermal budget can be suppressed compared to the conventional case of using lamp heating or resistance heating.

However, in the processing apparatus using a microwave, impedance matching between a microwave source and a load side is performed in order to maximize power utilization efficiency by reducing a reflection wave. An automatic matching using an EH tuner is suggested in, e.g., Japanese Patent Application Publication No. S63-264893 (claims and so on). In addition, a method for performing impedance matching between a microwave source and a processing chamber during processing of a substrate in a microwave heating processing apparatus is suggested in Japanese Patent Application Publication No. 2013-58652 (FIG. 7 and so on).

The impedance matching in the microwave heating apparatus is an operation of performing tuning so that the reflection power from the processing chamber is minimized. Generally, the matching is performed in a state where the substrate is maintained at a constant height in the processing chamber. However, the height of the substrate at which the matching is performed is not necessarily identical to a height at which the microwave utilization efficiency is maximized. For example, if a state change such as temperature increase or the like occurs at a member (e.g., the processing chamber or the like) other than a substrate during the processing of the substrate in the microwave heating apparatus, the reflection wave may be increased considerably. This indicates that even after the matching is performed, the impedance between the microwave source and the processing chamber may be considerably changed in accordance with the state change of the member other than the substrate. Therefore, even if the matching is performed so that the reflection power is minimized in a state where the substrate is maintained at a certain height position, the microwave utilization efficiency may not be maximized.

### SUMMARY OF THE INVENTION

In view of the above, the present invention provides a matching method and a microwave heating method capable of heating a substrate by effectively using a microwave by reducing a reflection wave in a microwave heating apparatus.

In accordance with the present invention, there is provided an impedance matching method for matching an impedance between a microwave source and a processing chamber in a microwave heating apparatus for performing heat treatment by irradiating a microwave to a substrate supported by a supporting member, the apparatus including: the processing chamber for accommodating the substrate; the supporting member for supporting the substrate in the processing chamber; and a microwave introducing unit having the microwave source for generating the microwave and introducing the microwave into the processing chamber, the method comprising: an initial matching step of performing the matching so that a reflection power to the microwave introducing unit is minimized in a state where the substrate is maintained at a first height position by the supporting member; and a second height position determination step of introducing the microwave into the processing chamber by the microwave introducing unit and determining a second height position of the substrate based on at least a temperature of the substrate while adjusting a height of the substrate by the supporting member.

In accordance with another aspect of the present invention, there is provided a microwave heating method for performing heat treatment using a microwave heating apparatus including: a processing chamber for accommodating a substrate; a supporting member for supporting the substrate in the processing chamber; and a microwave introducing unit having a microwave source for generating a microwave and introducing the microwave into the processing chamber, the method comprising: an initial matching step of performing impedance matching between the microwave source and the processing chamber so that a reflection power to the microwave introducing unit is minimized in a state where the substrate is maintained at a first height position by the supporting member; a second height position determination step of introducing the microwave into the processing chamber by the microwave introducing unit and determining a second height position of the substrate based on at least a temperature of the substrate while adjusting a height of the substrate by the supporting member; and a heating step of irradiating the microwave introduced into the processing chamber by the microwave introducing unit to the substrate maintained at the second height position.

In accordance with the matching method and the microwave heating method of the present invention, the substrate can be heated by effectively using a microwave by reducing a reflection wave.

### BRIEF DESCRIPTION OF THE DRAWINGS

The objects and features of the present invention will become apparent from the following description of embodiments, given in conjunction with the accompanying drawings, in which:

FIG. 1 is a cross sectional view showing a schematic configuration of a microwave heating apparatus used for a microwave heating method in accordance with an embodiment of the present invention;

FIG. 2 is a plan view showing a bottom surface of a ceiling portion of a processing chamber shown in FIG. 1;

FIG. 3 explains a schematic configuration of a high voltage power supply unit of the microwave heating apparatus shown in FIG. 1;

FIG. 4 is a block diagram showing a hardware configuration of a control unit;

FIG. 5 is a flowchart showing an example of a sequence of the microwave heating method in accordance with the embodiment of the present invention;

FIG. 6 is a graph showing relationship between a height position of a semiconductor wafer (vertical axis) and a reflection power (horizontal axis) in a test example;

FIG. 7 is a graph showing relationship between the height position of the semiconductor wafer (vertical axis) and a temperature at a central portion of the semiconductor wafer (horizontal axis) in the test example;

FIG. 8 is a graph showing relationship between the height position of the semiconductor wafer (vertical axis) and a temperature at an intermediate portion of the semiconductor wafer (horizontal axis) in the test example;

FIG. 9 is a graph showing relationship between the height position of the semiconductor wafer (vertical axis) and a temperature at an edge portion of the semiconductor wafer (horizontal axis) in the test example;

FIG. 10 is a graph plotting relationship between the height position of the semiconductor wafer (vertical axis) and reflection powers of four magnetrons (horizontal axis); and

FIG. 11 is a graph plotting relationship among the height position of the semiconductor wafer, maximum temperatures at the central portion and the edge portion of the semiconductor wafer and a difference therebetween Δt.

### DETAILED DESCRIPTION OF THE EMBODIMENTS

Hereinafter, embodiments of the present invention will be described in detail with reference to the accompanying drawings.

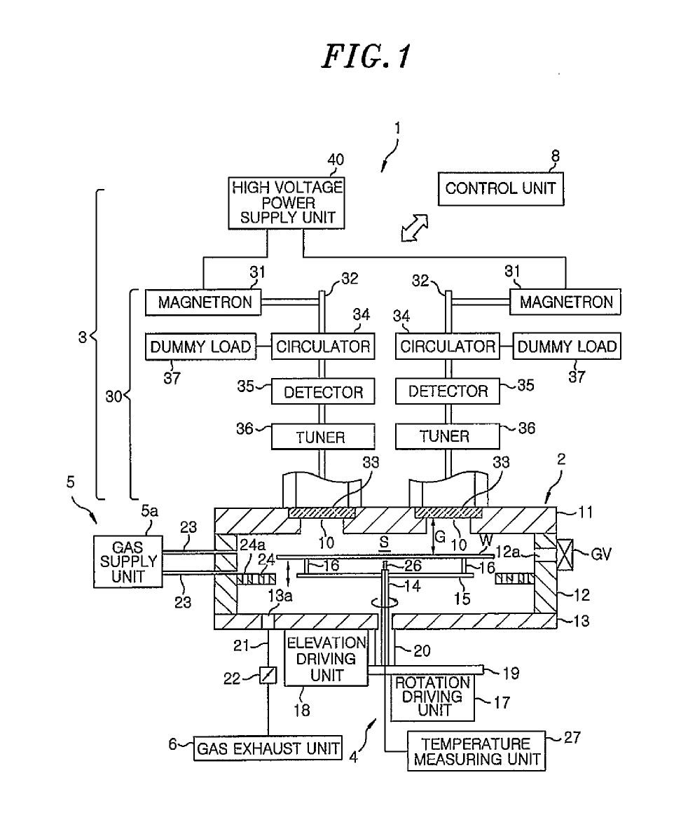

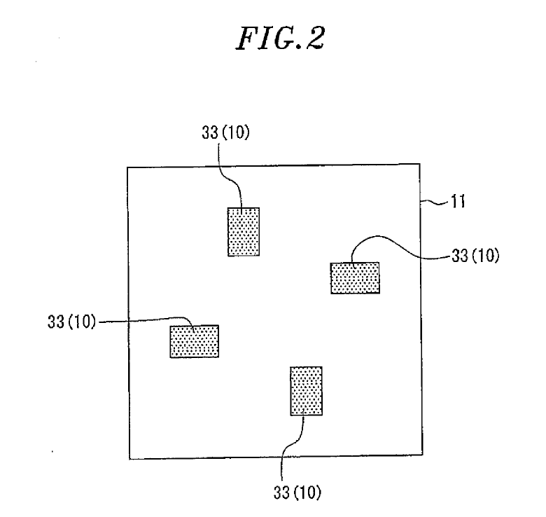

First, a microwave heating apparatus used for a microwave heating method in accordance with an embodiment of the present invention will be described with reference to FIG. 1. FIG. 1 is a cross sectional view showing a schematic configuration of the microwave heating apparatus. FIG. 2 is a plan view showing a bottom surface of a ceiling portion of a processing chamber shown in FIG. 1. A microwave heating apparatus 1 performs annealing by irradiating a microwave onto, e.g., a semiconductor wafer for manufacturing a semiconductor device (hereinafter, simply referred to as “wafer”) through a plurality of consecutive operations. Here, between an upper and a lower surface of a flat wafer W, the upper surface is used as a semiconductor device forming surface and as a main surface to be processed.

The microwave heating apparatus 1 includes: a processing chamber 2 for accommodating a wafer W as an object to be processed; a microwave introducing unit 3 for introducing a microwave into the processing chamber 2; a supporting unit 4 for supporting the wafer W in the processing chamber 2; a gas supply mechanism 5 for supplying a gas into the processing chamber 2; a gas exhaust unit 6 for evacuating the processing chamber 2; and a control unit 8 for controlling the respective components of the microwave heating apparatus 1.

(Processing Chamber)

The processing chamber 2 is made of metal. The processing chamber 2 may be made of, e.g., aluminum, aluminum alloy, stainless steel or the like. The microwave introducing unit 3 is provided above the processing chamber 2 to introduce a microwave into the processing chamber 2. The configuration of the microwave introducing unit 3 will be described in detail later.

The processing chamber 2 includes a plate-shaped ceiling portion 11 serving as an upper wall, a bottom portion 13 serving as a bottom wall, four sidewalls 12 connecting the ceiling portion 11 and the bottom portion 13; a plurality of microwave inlet ports 10 vertically penetrating through the ceiling portion; a loading/unloading port 12a provided at one sidewall 12, and a gas exhaust port 13a provided at the bottom portion 13. Here, the four sidewalls 12 are connected at right angles to each other, thereby forming a square column shape. Therefore, the processing chamber 2 has a hollow cubic shape. Further, each sidewall 12 has a flat inner surface serving as a reflection surface for reflecting the microwave. The wafer W is transferred between the processing chamber 2 and a transfer chamber (not shown) adjacent to the processing chamber 2 through the loading/unloading port 12a. A gate valve GV is provided between the processing chamber 2 and the transfer chamber (not shown). The gate valve GV has a function of opening/closing the loading/unloading port 12a. The gate valve GV in a closed state airtightly seals the processing chamber 2. The gate valve GV in an open state allows the wafer W to be transferred between the processing chamber 2 and the transfer chamber (not shown).

(Supporting Unit)

The supporting unit 4 includes: a pipe-shaped shaft 14 extending to the outside of the processing chamber 2 while penetrating through an approximate center of the bottom portion 13 of the processing chamber 2; a plurality of (e.g., three) arms 15 extending in a substantially horizontal direction from the vicinity of the upper end of the shaft 14; a plurality of supporting pins 16 detachably attached to the arms 15; a rotation driving unit 17 for rotating the shaft 14; an elevation driving unit 18 for vertically displacing the shaft 14; and a movable connection unit 19 for connecting the rotation driving unit 17 and the elevation driving unit 18 while supporting the shaft 14. The rotation driving unit 17, the elevation driving unit 18 and the movable connection unit 19 are provided at the outside of the processing chamber 2. Further, a seal mechanism 20, e.g., a bellows or the like, may be provided around a portion where the shaft 14 penetrates through the bottom portion 13 in case of setting the inside of the processing chamber 2 in a vacuum state.

In the supporting unit 4, the shaft 14, the arms 15, the rotation driving unit 17 and the movable connection unit 19 constitute a rotation unit for horizontally rotating the wafer W supported by the supporting pins 16. Further, in the supporting unit 4, the shaft 14, the arms 15, the elevation driving unit 18 and the movable connection unit 19 constitute a height position adjusting unit for adjusting a height position of the wafer W supported by the supporting pins 16. The supporting pins 16 support the wafer W while being in contact with the backside of the wafer W in the processing chamber 2. The supporting pins 16 are provided such that the end portions thereof are arranged in a circumferential direction of the wafer W. The arms 15 are rotated about the shaft 14 by driving the rotation driving unit 17, thereby horizontally revolving the supporting pins 16. The supporting pins 16 and the arms 15 are vertically displaced together with the shaft 14 by driving the elevation driving unit 18.

The supporting pins 16 and the arms 15 are made of a dielectric material. The supporting pins 16 and the arms 15 may be made of, e.g., quartz, ceramic or the like.

The rotation driving unit 17 is not particularly limited as long as it can rotate the shaft 14, and may include, e.g., a motor (not shown) or the like. The elevation driving unit 18 is not particularly limited as long as it can vertically displace the shaft 14 and the movable connection unit 19, and may include, e.g., a ball screw (not shown) or the like. The rotation driving unit 17 and the elevation driving unit 18 may be formed as one unit, and the configuration that does not include the movable connection unit 19 may be employed. Further, the rotation unit for horizontally rotating the wafer W and the height position adjusting unit for adjusting the height position of the wafer W may have different configurations as long as the functions thereof can be realized.

(Gas Exhaust Unit)

The gas exhaust unit 6 includes a vacuum pump, e.g., a dry pump or the like. The microwave heating apparatus 1 further includes a gas exhaust line 21 that connects the gas exhaust port 13a and the gas exhaust unit 6, and a pressure control valve 22 disposed on the gas exhaust line 21. By driving the vacuum pump of the gas exhaust unit 6, the inside of the processing chamber 2 is evacuated. Further, the microwave heating apparatus 1 may perform a process under an atmospheric pressure. In that case, the vacuum pump is not required. Instead of using the vacuum pump such as a dry pump or the like, it is also possible to use gas exhaust equipments provided at a facility where the microwave heating apparatus 1 is installed.

(Gas Introducing Mechanism)

The microwave heating apparatus 1 further includes a gas supply mechanism 5 for supplying a gas into the processing chamber 2. The gas supply mechanism 5 includes: a gas supply unit 5a having a gas supply source (not shown); and a plurality of lines 23 (only two shown) connected to the gas supply unit 5a, for introducing a processing gas into the processing chamber 2. The lines 23 are connected to the sidewall 12 of the processing chamber 2.

The gas supply unit 5a is configured to supply a processing gas, e.g., N₂, Ar, He, Ne, O₂, H₂ or the like, into the processing chamber 2 in a side flow manner through the lines 23. Further, the gas supply into the processing chamber 2 may be performed by a gas supply device provided at a position at face the wafer W, e.g., at the ceiling portion 11. Moreover, an external gas supply device that is not included in the configuration of the microwave heating apparatus 1 may be used instead of the gas supply unit 5a. Although it is not illustrated, the microwave heating apparatus 1 further includes a mass flow controller and an opening/closing valve which are disposed on the line 23. A type or a flow rate of the gas supplied into the processing chamber 2 is controlled by the mass flow controller and the opening/closing valve.

(Rectifying Plate)

The microwave heating apparatus 1 further includes a frame-shaped rectifying plate 24 disposed between the sidewall 12 and the periphery of the supporting pins 16 in the processing chamber 2. The rectifying plate 24 has a plurality of rectifying holes 24a vertically penetrating through the rectifying plate 24. The rectifying plate 24 rectifies an atmosphere of a region where the wafer W will be disposed in the processing chamber 2 and allows the gas in the region to flow toward the gas exhaust port 13a. The rectifying plate 24 is made of metal, e.g., aluminum, aluminum alloy, stainless steel or the like. The rectifying plate 24 is not necessary for the microwave heating apparatus 1 and thus may not be provided.

(Temperature Measurement Unit)

The microwave heating apparatus 1 further includes a plurality of radiation thermometers 26 for measuring a surface temperature of the wafer W, and a temperature measuring unit 27 connected to the radiation thermometers 26. In FIG. 1, the illustration of the radiation thermometers 26 is omitted except the radiation thermometer 26 for measuring a surface temperature at the central portion of the wafer W.

(Microwave Radiation Space)

In the microwave heating apparatus 1 of the present embodiment, a microwave radiation space S is defined by the ceiling portion 11, the four sidewalls 12 and the rectifying plate 24 in the processing chamber 2. In the microwave radiation space S, a microwave is irradiated from the microwave inlet ports 10 provided at the ceiling portion 11. Since the ceiling portion 11, the four sidewalls 12 and the rectifying plate 24 of the processing chamber 2 are made of metal, the microwave is reflected and scattered in the microwave radiation space S.

(Microwave Introducing Unit)

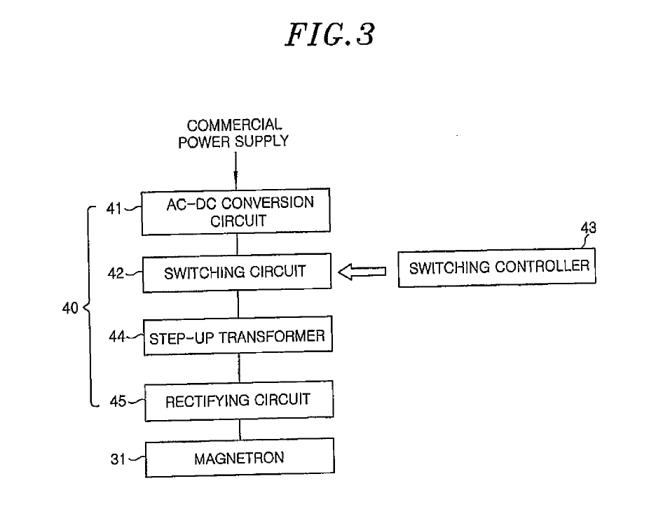

Hereinafter, the configuration of the microwave introducing unit 3 will be described with reference to FIGS. 1 to 3. FIG. 3 explains a schematic configuration of a high voltage power supply unit of the microwave introducing unit 3. As described above, the microwave introducing unit 3 is provided above the processing chamber 2 and introduces a microwave into the processing chamber 2. As shown in FIG. 1, the microwave introducing unit 3 includes: a plurality of microwave units 30 for introducing a microwave into the processing chamber 2; and a high voltage power supply unit 40 connected to the microwave units 30

(Microwave Unit)

In the present embodiment, the microwave units 30 have the same configuration. Each microwave unit 30 includes: a magnetron 31 for generating a microwave for processing the wafer W; a waveguide 32 serving as a transmission path for transmitting the microwave generated by the magnetron 31 to the processing chamber 2; and a transmission window 33 fixed to the ceiling portion 11 to block the microwave inlet ports 10. The magnetron 31 corresponds to the microwave source of the present invention.

As shown in FIG. 2, in the present embodiment, the four microwave inlet ports 10 spaced apart from each other at a regular interval in a circumferential direction are formed at the ceiling portion 11 of the processing chamber 2. Each microwave inlet port 10 has a rectangular shape with short sides and long sides in a plan view. The microwave inlet ports 10 may have different sizes or different ratios between the long sides and the short sides. However, it is preferable that the four microwave inlet ports 10 have the same size and the same shape in view of improvement of the uniformity of the annealing process for the wafer W and the controllability. Further, in the present embodiment, the microwave units 30 are connected to the microwave inlet ports 10, respectively. In other words, the number of the microwave units 30 is four.

The magnetron 31 has an anode and a cathode (both not shown) to which a high voltage from the high voltage power supply unit 40 is applied. As for the magnetron 31, it is possible to use one capable of oscillating microwaves of various frequencies. The frequency of the microwave generated by the magnetron 31 is optimally selected in accordance with types of processing for an object to be processed. For example, in case of an annealing process, a microwave having a high frequency of 2.45 GHz, 5.8 GHz or the like is preferably used, and a microwave having a high frequency of 5.8 GHz is more preferably used.

The waveguide 32 has a square column shape having a rectangular cross section and extends upward from the top surface of the ceiling portion 11 of the processing chamber 2. The magnetron 31 is connected to the vicinity of the upper end portion of the waveguide 32. The lower end portion of the waveguide 32 is in contact with the top surface of the transmission window 33. The microwave generated by the magnetron 31 is introduced into the processing chamber 2 through the waveguide 32 and the transmission window 33.

The transmission window 33 is made of a dielectric material. As for the material of the transmission window 33, it is possible to use, e.g., quartz, ceramic or the like. A gap between the transmission window 33 and the ceiling portion 11 is airtightly sealed by a seal member (not shown). A distance (gap G) from the bottom surface of the transmission window 33 to the surface of the wafer W supported by the supporting pins 16 is preferably set to, e.g., about 25 mm or above, in view of suppression of direct irradiation of the microwave to the wafer W. More preferably, the distance is controlled within a range from 25 mm to 50 mm.

The microwave unit 30 further includes a circulator 34, a detector 35 and a tuner 36 which are disposed on the waveguide 32, and a dummy load 37 connected to the circulator 34. The circulator 34, the detector 35 and the tuner 36 are provided in that order from the upper end side of the waveguide 32. The circulator 34 and the dummy load 37 constitute an isolator for separating a reflection wave from the processing chamber 2. In other words, the circulator 34 guides the reflection wave from the processing chamber 2 to the dummy load 37, and the dummy load 37 converts the reflection wave guided by the circulator 34 into heat.

The detector 35 detects the reflection wave from the processing chamber 2 in the waveguide 32. The detector 35 includes, e.g., impedance monitor, specifically, a standing wave monitor for detecting an electric field of a standing wave in the waveguide 32. The standing wave monitor may include, e.g., three pins protruding into an inner space of the waveguide 32. The reflection wave from the processing chamber 2 can be detected by detecting the location, the phase, the intensity of the electric field of the standing wave by using the standing wave monitor. Further, the detector 35 may include a directional coupler capable of detecting a traveling wave and a reflection wave.

The tuner 36 has a function of performing impedance matching between the magnetron 31 and the processing chamber (hereinafter, may be simply referred to as “matching”). The tuner 36 performs the matching based on the detection result of the reflection wave by the detector 35. The tuner 36 may include, e.g., a conductive plate (not shown) capable of protruding into and retreating from the inner space of the waveguide 32. In that case, the impedance between the magnetron 31 and the processing chamber 2 can be controlled by adjusting the power of the reflection wave by controlling the protruding amount of the conductive plate into the inner space of the waveguide 32.

(High Voltage Power Supply Unit)

The high voltage power supply unit 40 supplies to the magnetron 31 a high voltage for generating a microwave. As shown in FIG. 3, the high voltage power supply unit 40 includes: an AC-DC conversion circuit 41 connected to a commercial power supply; a switching circuit 42 connected to the AC-DC conversion circuit 41; a switching controller 43 for controlling an operation of the switching circuit 42; a step-up transformer 44 connected to the switching circuit 42; and a rectifying circuit 45 connected to the step-up transformer 44. The magnetron 31 is connected to the step-up transformer 44 via the rectifying circuit 45.

The AC-DC conversion circuit 41 rectifies an AC, e.g., three phase 200V AC, supplied from the commercial power supply and converts it to a DC having a predetermined waveform. The switching circuit 42 controls on/off of the DC current converted by the AC-DC conversion circuit 41. In the switching circuit 42, the switching controller 43 performs phase-shift PWM (pulse width modulation) control or PAM (pulse amplitude modulation) control, thereby generating a pulsed voltage waveform. The step-up transformer 44 boosts the voltage waveform output from the switching circuit 42 to a predetermined level. The rectifying circuit 45 rectifies the voltage boosted by the step-up transformer 44 and supplies the rectified voltage to the magnetron 31.

(Control Unit)

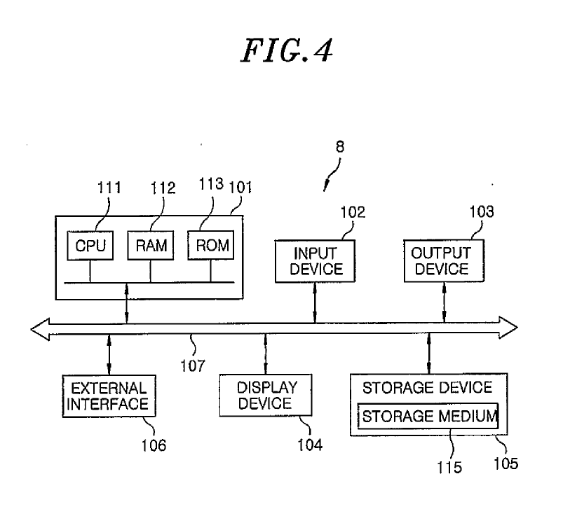

The respective components of the microwave heating apparatus 1 are connected to and controlled by the control unit 8. The control unit 8 is typically a computer. FIG. 4 shows an example of a hardware configuration of the control unit 8 shown in FIG. 1. The control unit 8 includes a main control unit 101, an input device 102 such as a keyboard, a mouse or the like, an output device 103 such as a printer or the like, a display device 104, a storage device 105, an external interface 106, and a bus 107 for connecting these components. The main control unit 101 has a CPU (central processing unit) 111, a RAM (Random Access Memory) 112 and a ROM (Read Only Memory) 113. The storage device 105 is not particular limited as long as the information can be stored, and may be, e.g., a hard disk device or an optical disk device. The storage device 105 stores the information in a computer readable storage medium 115 and reads out the information from the storage medium 115. The storage medium 115 is not particularly limited as long as the information can be stored, and may be, e.g., a hard disk, an optical disk, a flash memory or the like. The storage medium 115 may store a recipe of a plasma etching method of the present embodiment.

In the control unit 8, the CPU 111 executes the program stored in the storage device 105 or the ROM 113 while using the RAM 112 as a working area, so that the microwave heating apparatus 1 of the present embodiment can heat the wafer W. Specifically, the control unit 8 controls the respective components (e.g., the microwave introducing unit 3, the supporting unit 4, the gas supply unit 5a, the gas exhaust unit 6 and the like) related to processing conditions, e.g., a temperature of the wafer W, a pressure in the processing chamber 2, a gas flow rate, a microwave output, a rotation speed of the wafer W and the like, in the microwave heating apparatus 1.

In the microwave heating apparatus 1 configured as described above, uniform heat treatment can be performed by reducing heating temperature variation in the surface of the wafer W.

[Matching Method and Microwave Heating Method]

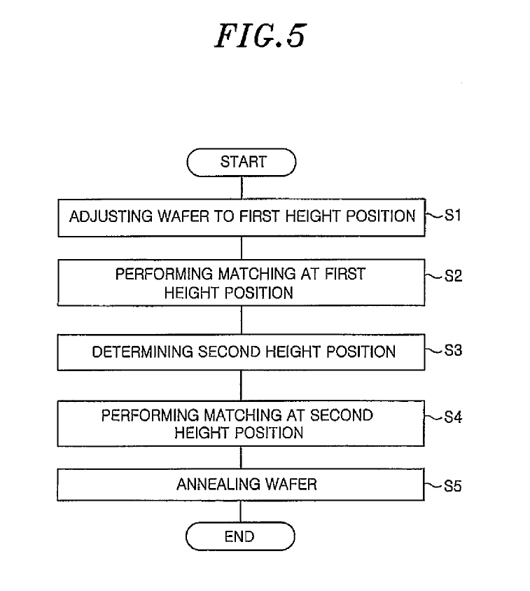

Hereinafter, a matching method and a microwave heating method performed by the microwave heating apparatus 1 will be described. FIG. 5 is a flowchart showing an example of a sequence of the microwave heating method of the present embodiment. As shown in FIG. 5, the microwave heating method of the present embodiment includes steps S1 to S5. Among the steps S1 to S5, the steps S1 to S4 correspond to sequences of the matching method in accordance with an embodiment of the present invention. In other words, the microwave heating method of the present embodiment includes the matching method in accordance with the embodiment of the present invention.

First, the gate valve GV is opened. A wafer W for matching is loaded into the processing chamber 2 through the gate valve GV and the loading/unloading port 12a and mounted on the supporting pins 16 by a transfer device (not shown).

(Step S1)

First in the step S1, the wafer W is adjusted to a first height position. Specifically, the wafer W is set to the first height position by vertically displacing the supporting pins 16 holding the wafer W by using the elevation driving unit 18 of the supporting unit 4. The first height position can be set to any position. As described above, the first height position is preferably set such that the gap G is, e.g., 25 mm or above, and more preferably set such that the gap G is 25 mm to 50 mm. Further, the first height position is spaced from the inner wall of the bottom portion 13 preferably by 25 mm or above and more preferably by 25 mm to 45 mm.

(Step S2)

Next, in a step S2, the microwave is introduced from the microwave introducing unit 3 into the processing chamber 2 in a state where the wafer W is maintained at the first height position. The matching between the magnetrons 31 and the processing chamber 2 is performed so that the reflection power to the waveguide 32 is minimized. The matching is sequentially performed for each of the four magnetrons 31 by generating microwaves by the four magnetrons 31 and separately introducing the microwaves from the four microwave inlet ports 10. The matching is performed by allowing the detector 35 in the waveguide 32 to detect a reflection wave of the microwave generated by a corresponding magnetron 31 and introduced into the processing chamber 2 through a corresponding waveguide 32 and a corresponding microwave inlet port 10 and the tuner 36 to perform control so that the power of the reflection wave is minimized. When the tuner 36 is formed by the aforementioned conductive plate, the matching can be performed by controlling the protruding amount of the conductive plate into the inner space of the waveguide 32.

The steps S1 and S2 correspond to the initial matching step in the matching method of the present embodiment.

(Step S3)

Next, in a step S3, a second height position is determined using, as an index, at least a temperature of the substrate. Specifically, in the step S3, the wafer W is heated by introducing the microwave into the processing chamber 2 under predetermined microwave introduction conditions by the microwave introducing unit 3. The microwave introduction conditions are preferably the same as those for an annealing process for the wafer W in a step S5 to be described later. The supporting pins 16 holding the wafer W are vertically displaced by the elevation driving unit 18 of the supporting unit 4. For example, the height position of the wafer W is changed by 0.5 mm in a stepwise manner, and temperature data at each height position is acquired. At this time, the temperature of the wafer W heated with microwaves generated by all of the four magnetrons 31 is measured by the temperature measuring unit 27. Preferably, the temperature of the wafer W is measured at multiple locations, e.g., the central portion and the edge portion of the wafer W, and the intermediate portion between the central portion and the edge portion. Moreover, a maximum value or an average at each location may be calculated from the acquired temperature data. Here, the central portion of the wafer W indicates a region within about 2/6 of the radius from the center of the wafer W. The edge portion of the wafer W indicates a region within about 1/6 of the radius from the edge of the wafer W inward. The intermediate portion of the wafer W indicates a region outer than the central portion and inner than the edge portion. For example, in case of a circular wafer W having a diameter of, e.g., 300 mm, a central portion is a region within a radius of 50 mm from the center of the wafer W; an intermediate portion is a region within a radius of 50 mm to 100 mm from the center; and an edge portion is a region within a radius of 100 mm to 150 mm (edge of the wafer W) from the center.

The temperature data of the wafer W which is used as the index in the step S3 may be, e.g., as follows.

i) temperature measured at a single location of the wafer W,

ii) maximum value among temperatures measured at multiple locations of the wafer W,

iii) average of temperatures measured at multiple locations of the wafer W,

iv) average, at a specific region, of temperatures measured at multiple locations of the wafer W, or

v) maximum value among averages, at multiple regions, of temperatures measured at multiple locations of the wafer W.

Here, the regions referred in the fourth and the fifth temperature data may include, e.g., the central portion and the edge portion of the wafer W, and the intermediate portion between the central portion and the edge portion.

In the step S3, it is preferable to determine, as the second height position, the height position of the wafer W where a value of at least any one of the first to the fifth temperature data is largest. However, in consideration of the case of using an additional index such as a reflection wave, a temperature difference in the surface of the wafer W or the like, the second height position is not restricted to the height position of the wafer W where the value of any one of the above temperature data is largest and may be set to a height position where the value of the temperature data is comparatively large (e.g., second largest, third largest and so on). For example, if the reflection power is large or the temperature difference in the surface of the wafer W is large, the height position of the wafer W where the value of the temperature data of the wafer W is largest, is not determined as the second height position, and the second height position can be determined, in consideration of the balance with the additional index, from the height position where the value of the temperature data is second largest, third largest and so on. A specific sequence of determining the second height position will be described later.

In the step S3, an additional index may be, e.g., as follows.

a) difference in temperatures measured at multiple locations of the wafer W, or

b) reflection power to the microwave introducing unit 3.

Such an additional index can be used together with the first to the fifth temperature data.

Further, both of the additional indexes may be used.

As the first additional index, i.e., the difference in the temperatures measured at multiple locations of the wafer, is decreased, the in-plane uniformity of the wafer W is improved, which is preferable. As for the temperature difference, it is possible to select one or at least two among, e.g., a temperature difference between a measurement location at the central portion and a measurement location at the edge portion of the wafer, a temperature difference between a measurement location at the central portion and a measurement location at the intermediate portion of the wafer W, a temperature difference between a measurement location at the intermediate portion and a measurement location at the edge portion of the wafer W, or the like. The temperature difference may be a difference among averages of temperatures measured at multiple locations represented by the central portion, the intermediate portion, and the edge portion of the wafer W. In the present embodiment, any one of the temperature differences may be used as the additional index for determining the second height position by comparison with a preset threshold. In that case, if the temperature difference is smaller than the threshold, the heating temperature variation in the surface of the wafer W is within a predetermined range. By using the threshold, the second height position can be determined in consideration of the in-plane uniformity of the wafer W. Accordingly, the uniformity of the heat treatment in the surface of the wafer W can be improved.

As the second additional index, i.e., the reflection power, is decreased, the microwave power utilization efficiency is improved, which is preferable. The reflection power may be, e.g., an individual reflection power to each of the magnetrons 31 or a total reflection power to the magnetrons 31. The reason that the reflection power is used as the additional index in the step S3 is because the height position of the wafer W needs to be changed to determine the second height position and this may cause a considerable change in the impedance between the magnetron 31 and the processing chamber 2.

In the present embodiment, any one of the reflection power may be used as the additional index for determining the second height position by comparison with the preset threshold. In that case, the threshold is used as an index for determining whether or not the reflection power is within a tolerable range. The threshold is previously set and stored as a part of a recipe in the storage device 105 of the control unit 8, for example. A reference of the threshold may be, e.g., a value corresponding to 20% preferably 18% and more preferably 15% of the total microwave power output from all the microwave sources. For example, when the total power of the reflection wave is smaller than or equal to, e.g., 20% of the total output from the four microwave sources, the reflection power is smaller than the threshold and thus is within the tolerable range. By using the threshold, the height position where the reflection power is extremely increased is not selected as the second height position and, thus, the microwave power utilization efficiency can be increased. As in the case of the matching in the step S2, the reflection power can be obtained by detecting the reflection wave of the microwave generated by the magnetrons 31 and introduced into the processing chamber 2 through the waveguides 32 and the microwave inlet ports 10 by the detector 35 of the waveguide 32.

In the step S3, the second height position is determined among a plurality of height positions by using the above-described index and additional index, if necessary.

A specific method for determining the second height position in the step S3 may include the following sequences, for example.

Sequence 1) The height position of the wafer W where the value of at least one of the first to the fifth temperature data is largest is determined as the second height position. In that case, the additional index is not considered.

Sequence 2) At least one of the first to the fifth temperature data having a largest value is set to the reference data. The second height position is determined, in consideration of the additional index, among height positions where the value of the temperature data is 90% or above of that of the reference temperature data. For example, among the height positions where the value of the temperature data is 90% or above of that of the reference temperature data, the height position where the additional index a and/or b has a largest value or the height position where the additional index a and/or b is smaller than or equal to a predetermined threshold is determined as the second height position.

The second height position is preferably set such that the gap G is, e.g., 25 mm or above, and more preferably set such that the gap G is 25 mm to 50 mm, as described above. Further, the second height position is spaced from the inner wall of the bottom portion 13 preferably by 25 mm or above and more preferably by 25 mm to 45 mm.

The step S3 corresponds to the second height position determination step in the matching method of the present embodiment.

(Step S4)

Next, in a step S4, the microwave is introduced from the microwave introducing unit 3 into the processing chamber 2 in a state where the wafer W is held at the second height position. Further, the matching between the magnetron 31 and the processing chamber 2 is performed so that the reflection power to the waveguide 32 is minimized. Specifically, first, the wafer W is set to the second height position by vertically displacing the supporting pins 16 holding the wafer W for matching by the elevation driving unit 18 of the supporting unit 4. The matching is sequentially performed for each of the four magnetrons 31 by generating microwaves by the four magnetrons 31 and separately introducing the microwaves from the four microwave inlet ports 10. The matching is performed by allowing the detector 35 to detect a reflection wave of the microwave generated by a corresponding magnetron 31 and introduced into the processing chamber 2 via a corresponding waveguide 32 and a corresponding microwave inlet port 10 and the tuner 36 to perform control so that the power of the reflection wave is minimized. When the tuner 36 is formed by the aforementioned conductive plate, the matching can be performed by controlling the protruding amount of the conductive plate into the inner space of the waveguide 32.

The step S4 corresponds to a re-matching step in the matching method of the present embodiment.

(Step S5)

Next, in a step S5, the microwave is introduced into the processing chamber 2 by the microwave introducing unit 3 and irradiated to the wafer W maintained at the second height position in order to heat the wafer W.

First, an instruction is input from the input device 102 of the control unit 8 to allow the microwave heating apparatus 1 to perform an annealing process, for example. Next, the main control unit 101 receives the instruction and reads out the recipe stored in the computer-readable storage medium 115 or the storage device 105. Then, the main control unit 101 transmits control signals to the respective end devices of the microwave heating apparatus 1, (e.g., the microwave introducing unit 3, the supporting unit 4, the gas supply unit 5a, the gas exhaust unit 6 and the like) so that the annealing process can be executed under the conditions based on the recipe.

Next, the gate valve GV is opened. The wafer W is loaded into the processing chamber 2 through the gate valve GV and the loading/unloading port 12a and mounted on the supporting pins 16 by a transfer device (not shown). By driving the elevation driving unit 18, the supporting pins 16 are displaced and the wafer W is set to the second height position determined in the step S3. At the second height, if necessary, the wafer W is horizontally rotated at a predetermined speed by driving the rotation driving unit 17 under the control of the control unit 8. The rotation of the wafer W may be non-consecutive. Next, the gate valve GV is closed and the processing chamber 2 is evacuated by the gas exhaust unit 6, if necessary. Then, the processing gas is introduced into the processing chamber 2 by the gas supply unit 5a, if necessary. The pressure in the processing chamber 2 is controlled to a predetermined level by controlling the gas exhaust amount and the gas supply amount.

Next, the microwave is generated by applying a voltage from the high voltage power supply unit 40 to the magnetron 31 under the control of the control unit 8. The microwave generated by the magnetron 31 propagates through the waveguide 32 and is introduced into a space above the rotating wafer W in the processing chamber 2 through the transmission window 33. In the present embodiment, microwaves are sequentially generated by the magnetrons 31 and alternately introduced into the processing chamber 2 from each of the microwave inlet ports 10. The microwaves may be simultaneously generated by the magnetrons 31 and simultaneously introduced into the processing chamber 2 from each of the microwave inlet ports 10.

The microwaves introduced into the processing chamber 2 are irradiated to the wafer W. The wafer W is rapidly heated by electromagnetic wave heating such as joule heating, magnetic heating, induction heating or the like. As a consequence, the wafer W is annealed.

During the annealing process, non-uniform distribution of the microwave irradiated to the wafer W is reduced by rotating the wafer W. Accordingly, the heating temperature in the surface of the wafer W can become uniform.

When the main control unit 101 transmits a control signal for completing the annealing process to the end devices of the microwave processing apparatus 1, the generation of the microwave is stopped. Also, the rotation of the wafer W and the supply of the processing gas and the cooling gas are stopped. In this manner, the annealing process of the wafer W is completed.

After the annealing process is performed for a predetermined period of time or after the cooling process following after the annealing process is completed, the gate valve GV is opened. The height position of the wafer W is adjusted by the supporting unit 4 and unloaded by the transfer device (not shown).

The microwave heating apparatus 1 is preferably used for annealing for activating doping atoms injected into the diffusion layer or the like in the semiconductor device manufacturing process, for example.

The matching in the steps S2 and S4 may be performed manually by an operator or by software (control program) for performing matching under the control of the control unit 8. In the step S3, the second height position may be determined by an operator by referring to the measured temperature of the wafer W or may be automatically determined by using software that performs an operation process based on the information on the measured temperature of the wafer W under the control of the control unit 8. The control unit 8 can execute a series of the steps S1 to S5 by using a plurality of software programs.

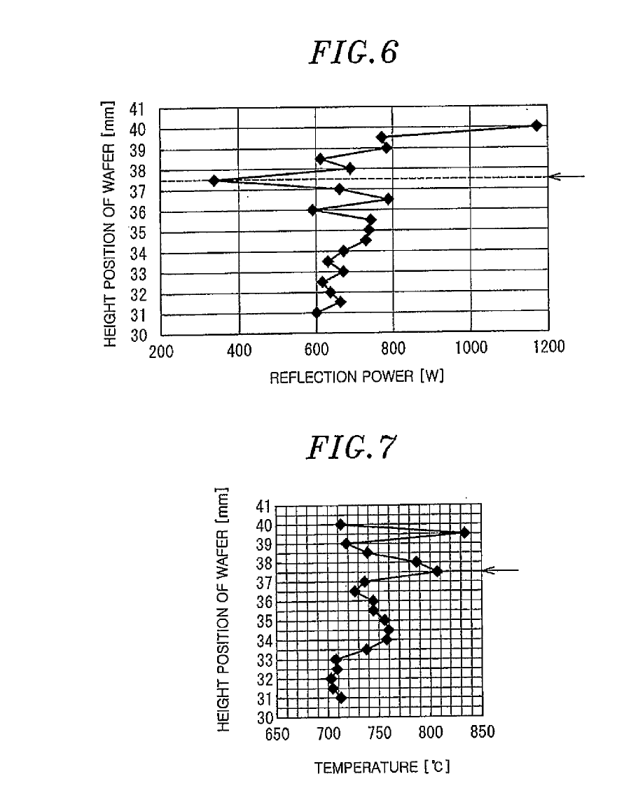

Hereinafter, a test result that has conceived the present invention will be described. First, the wafer W was supported by the supporting pins 16 of the supporting unit 4 at a height position spaced by 35 mm from the bottom portion of the processing chamber 2. Then, the impedance matching between the magnetron 31 and the processing chamber 2 was performed. Next, the height position of the wafer W was varied by the elevation driving unit 18 while introducing the microwave into the processing chamber 2 by the microwave introducing unit 3, and the reflection power at each height position was measured. The height position of the wafer W from the bottom portion 13 was displaced by 0.5 mm in a stepwise manner within a range of 31 mm to 40 mm. FIG. 6 is a graph showing relationship between the height position of the wafer W (vertical axis) and the reflection power (horizontal axis) in this test. In FIG. 6, the height of the wafer W indicates a distance from the inner wall surface of the bottom portion 13. The reflection power indicates the total power in the four transmission paths (the waveguides 32).

FIG. 6 shows that the reflection wave is greatly changed if the height position of the wafer W is changed after the impedance matching. Further, it was found that a reflection power at a certain height position of the wafer W is smaller than that at the height position (spaced from the bottom portion 13 by 35 mm) where the matching is performed. In this test, the reflection power was minimum when the height position of the wafer W was spaced from the bottom portion 13 by 37.5 mm.

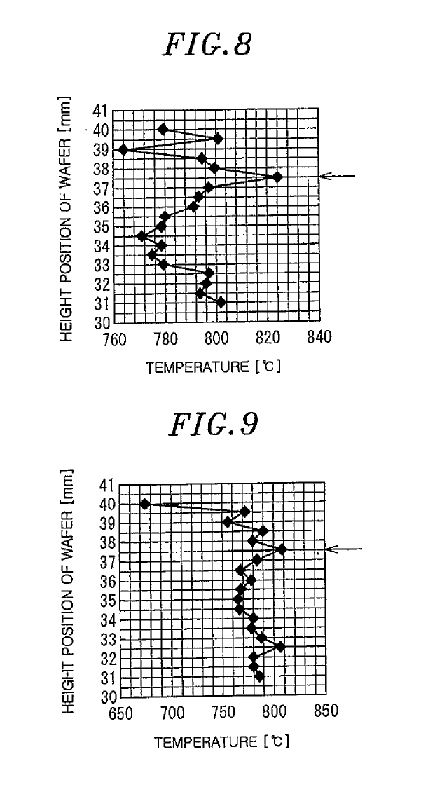

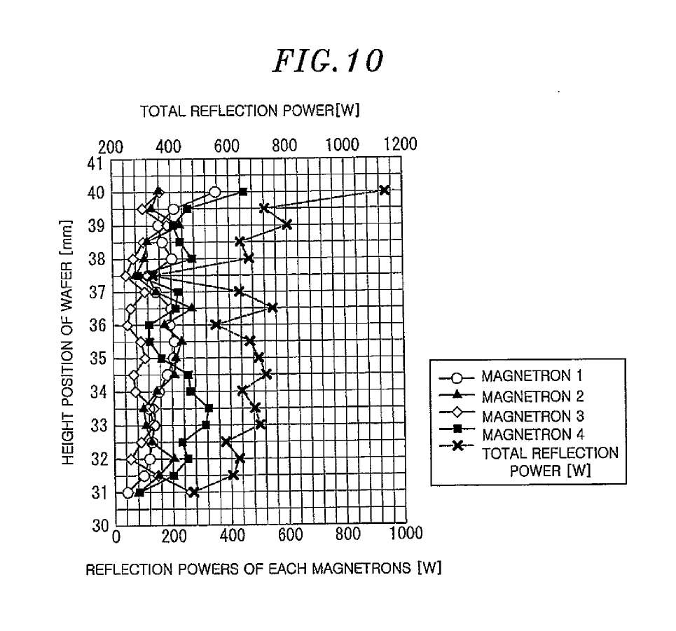

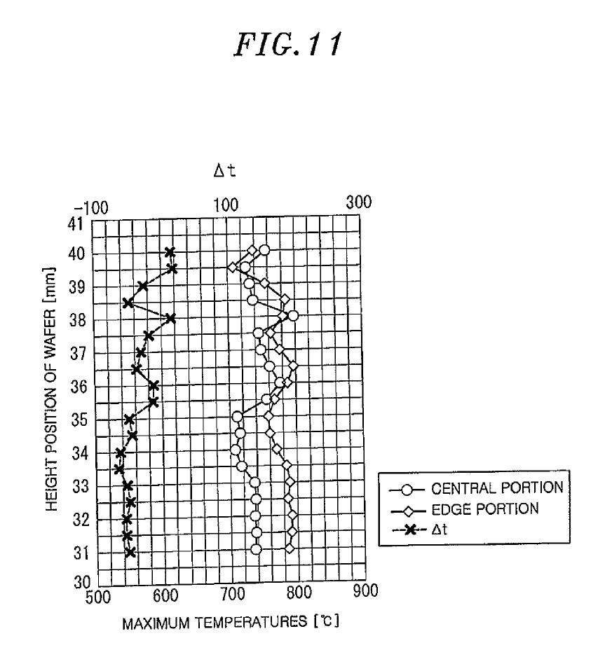

FIGS. 7 to 9 show temperature variation in different portions in the surface of the wafer W in this test. FIGS. 7 to 9 show temperature changes in the central portion, the intermediate portion and the edge portion of the wafer W, respectively. FIG. 10 is a graph plotting relationship between the height position of the wafer W and the reflection powers of the four magnetrons 31. In FIG. 10, for convenience, the four magnetrons 31 are referred to as “MAGNETRON 1”, “MAGNETRON 2”, “MAGNETRON 3” and “MAGNETRON 4”. FIG. 11 is a graph plotting relationship among the height position of the wafer W, maximum temperatures at the central portion and the edge portion of the wafer W, and a difference Δt therebetween (Δt=maximum temperature of the central portion−maximum temperature of the edge portion).

FIGS. 6 and 7 to 9 show that when the wafer W has a height position spaced from the bottom portion 13 by 37.5 mm, the reflection power is smallest and the temperature is high across the central portion, the intermediate portion and the edge portion of the wafer W, as indicated by arrows in the drawings. Referring to FIG. 7, the temperature of the central portion of the wafer W is highest at the height position spaced from the bottom portion 13 by 39.5 mm. However, referring to FIGS. 6 and 10, the reflection power is comparatively large and the power loss is large at such a height position. FIG. 11 shows that the difference Δt is greater at the height position spaced from the bottom portion 13 by 39.5 mm, which indicates the temperature distribution in the surface of the wafer W is non-uniform. However, the difference Δt is comparatively smaller and the uniformity of the temperature in the surface of the wafer W is high at the heating position spaced from the bottom portion 13 by 37.5 mm.

According to the above test results, the height position (spaced from the bottom portion 13 by 35 mm) where the impedance matching between the magnetron 31 and the processing chamber 2 is performed is different from the height position (spaced from the bottom portion 13 by 37.5 mm) where the power utilization efficiency is high and the wafer W can be effectively heated. In this case, the former corresponds to the first height position and the latter corresponds to the second height position in the present invention.

As described above, in the matching method of the present embodiment, the matching is performed in a state where the wafer W is maintained at the first height position. Then, the temperature is measured while displacing the height of the wafer W. Accordingly, the second height position in which the reflection wave is reduced and the wafer W can be effectively heated can be determined. In the microwave heating method of the present embodiment, the heat treatment is performed by irradiating the microwave to the wafer W maintained at the second height, the wafer W can be heated while effectively using the microwave by reducing the reflection wave.

The present invention may be variously modified without being limited to the above embodiments. For example, the microwave heating apparatus of the present invention is not limited to the case of using a semiconductor wafer as a substrate and may also be applied to a microwave heating apparatus using as a substrate, e.g., a substrate for a solar cell panel or a substrate for a flat panel display.

The number of the microwave units 30 (the magnetrons 31) or the number of the microwave inlet ports 10 in the microwave heating apparatus is not limited to that in the above embodiments.

While the invention has been shown and described with respect to the embodiments, it will be understood by those skilled in the art that various changes and modifications may be made without departing from the scope of the invention as defined in the following claims.

What is claimed is:

1. An impedance matching method for matching an impedance between a microwave source and a processing chamber in a microwave heating apparatus for performing heat treatment by irradiating a microwave to a substrate supported by a supporting member, the apparatus including: the processing chamber for accommodating the substrate; the supporting member for supporting the substrate in the processing chamber; and a microwave introducing unit having the microwave source for generating the microwave and introducing the microwave into the processing chamber, the method comprising:
an initial matching step of performing the matching so that a reflection power to the microwave introducing unit is minimized in a state where the substrate is maintained at a first height position by the supporting member; and
a second height position determination step of introducing the microwave into the processing chamber by the microwave introducing unit and determining a second height position of the substrate based on at least a temperature of the substrate while adjusting a height of the substrate by the supporting member.

2. The impedance matching method of claim 1, further comprising, after the second height position determination step, a rematching step of performing matching so that the reflection power to the microwave introducing unit is minimized in a state where the substrate is maintained at the second height position.

3. The impedance matching method of claim 1, wherein in the second height position determination step, the second height position is determined based on a maximum value among temperatures measured at multiple locations of the substrate.

4. The impedance matching method of claim 1, wherein in the second height position determination step, the second height position is determined based on an average of temperatures measured at multiple locations of the substrate.

5. The impedance matching method of claim 3, wherein in the second height position determination step, the second height position is determined further based on a difference in the temperatures measured at multiple locations of the substrate.

6. The impedance matching method of claim 5, wherein the temperature difference is compared with a preset threshold.

7. The impedance matching method of claim 1, wherein in the second height position determination step, the second height position is determined further based on reflection power to the microwave introducing unit.

8. The impedance matching method of claim 7, wherein the microwave heating apparatus further includes one or more microwave sources; and
in the second height position determination step, the second height position is determined further based on each individual reflection power to each of the microwave sources or the total sum of said each individual reflection power.

9. The impedance matching method of claim 8, wherein in the second height position determination step, said each individual reflection power or the total sum is compared with a preset threshold.

10. The impedance matching method of claim 1, wherein the microwave heating apparatus further includes one or more microwave sources; and
in the initial matching step, the matching is sequentially performed for the microwave sources.

11. The impedance matching method of claim 10, wherein the second height position determination step is performed in a state where the substrate is heated with microwaves generated by all of the microwave sources.

12. A microwave heating method for performing heat treatment using a microwave heating apparatus including: a processing chamber for accommodating a substrate; a supporting member for supporting the substrate in the processing chamber; and a microwave introducing unit having a microwave source for generating a microwave and introducing the microwave into the processing chamber, the method comprising:
an initial matching step of performing impedance matching between the microwave source and the processing chamber so that a reflection power to the microwave introducing unit is minimized in a state where the substrate is maintained at a first height position by the supporting member;
a second height position determination step of introducing the microwave into the processing chamber by the microwave introducing unit and determining a second height position of the substrate based on at least a temperature of the substrate while adjusting a height of the substrate by the supporting member; and
a heating step of irradiating the microwave introduced into the processing chamber by the microwave introducing unit to the substrate maintained at the second height position.

13. The microwave heating method of claim 12, further comprising, between the second height position determination step and the heating step, a rematching step of performing the matching so that the reflection power to the microwave introducing unit is minimized in a state where the substrate is maintained at the second height position.

14. The microwave heating method of claim 12, wherein the microwave heating apparatus further includes one or more microwave sources; and
in the initial matching step, the matching is sequentially performed for the microwave sources.

15. The microwave heating method of claim 14, wherein the second height position determination step is performed in a state where the substrate is heated with microwaves generated by all of the microwave sources.
